(19) United States
(12) Patent Application Publication
(10) Pub. No.: US 2009/0133842 A1
(43) Pub. Date: May 28, 2009

(54) TYRE BUILDING DRUM FOR BUILDING AN UNVULCANISED TYRE

(75) Inventors: Henk-Jan GROLLEMAN, VC Eerbeek (NL); Luuk Van Tienen, AJ Terwolde (NL); Jakob Pieter De Vries, DX Zwolle (NL)

Correspondence Address: LADAS & PARRY LLP, 26 WEST 61ST STREET, NEW YORK, NY, 10023, US

(73) Assignee: VMI HOLLAND B.V..

(21) Appl. No.: 12/275,250

(22) Filed: Nov. 21, 2008

Related U.S. Application Data
(60) Provisional application No. 61/004,290, filed on Nov. 26, 2007.

(51) Int. Cl. B29D 30/24

(52) U.S. Cl. 156/415

(57) ABSTRACT

Tyre building drum for building an unvulcanised tyre using tyre components of rubber. The tyre building drum comprises two folding arm units arranged at least substantially symmetrically with respect to the middle of the tyre building drum, which folding arm units are each connected to a folding arm bearing body so as to swivel. Both folding arm bearing bodies can be moved in axial direction of the tyre building drum. Via a first spindle both folding arm bearing bodies can be moved synchronously with respect to each other in axial direction. The tyre building drum further comprises two bead ring core units arranged at least substantially symmetrically with respect to the middle of the tyre building drum, each of the bead ring core units being intended for supporting a bead ring core. Each bead ring core unit comprises a bead ring core bearing body, wherein via a second spindle both bead ring core bearing bodies can be moved synchronously with respect to each other in axial direction. The first spindle and the second spindle are spaced apart from each other in radial direction.

### BACKGROUND OF THE INVENTION

The invention relates to a tyre building drum for building an unvulcanised tyre using tyre components of rubber, wherein the tyre building drum comprises two folding arm units arranged at least substantially symmetrically with respect to the middle of the tyre building drum, which folding arm units are each connected to a folding arm bearing body so as to swivel, wherein both folding arm bearing bodies can be moved in axial direction of the tyre building drum, wherein via a first spindle both folding arm bearing bodies can be moved synchronously with respect to each other in axial direction, wherein the tyre building drum further comprises two bead ring core units arranged at least substantially symmetrically with respect to the middle of the tyre building drum, each of the bead ring core units being intended for supporting a bead ring core, wherein each bead ring core unit comprises a bead ring core bearing body, wherein via a second spindle both bead ring core bearing bodies can be moved synchronously with respect to each other in axial direction.

Such a tyre building drum is known from EP-B1-1.439.054. In said known tyre building drum the first spindle is a base spindle, around which base spindle a hollow, the second spindle for the bead ring core units is coaxially arranged. The base spindle can be coupled to the hollow second spindle by means of a switchable coupling, so that both spindles can be coupled to each other and separately from each other. Although due to the use of particularly the base spindle, said known tyre building drum provides a considerable improvement with respect to other tyre building drums using a pneumatic drive for the folding arm bearing bodies, the known tyre building drum has some drawbacks. For instance the switchable coupling is not only a relatively expensive and complicated additional part, said switchable coupling is also difficult to repair in case of failure. Furthermore, due to using the two coaxial spindles the tyre building drum is relatively long and bulky.

### SUMMARY OF THE INVENTION

It is among others an object of the invention to provide a tyre building drum for building an unvulcanised tyre which is more maintenance-friendly and the design of which can be more compact.

For that purpose according to the invention a tyre building drum for building an unvulcanised tyre of the type mentioned in the preamble is characterised in that the first spindle and the second spindle are spaced apart from each other in radial direction. Indeed because the first and second spindle are spaced apart from each other, meaning that they are not coaxial, it is possible to drive each spindle by a separate drive. A specific coupling for coupling the spindles therefore is not necessary, which has a positive effect on the costs and the maintenance of the tyre building drum. Because the spindle are adjacent to each other the tyre building drum can also be designed shorter than the tyre building drum according to EP-B1-1.439.054. In said known tyre building drum the middle section of the base spindle namely is not threaded, and therefore cannot be used. The usable part of the base spindle needs to be outside of the hollow second spindle, as a result of which the overall length of the tyre building drum is unnecessarily increased. Because the spindles according to the present invention are adjacent to each other, the middle section of the spindles can also be usefully used, as a result of which the overall length of the tyre building drum can be shortened.

In an advantageous embodiment of a tyre building drum according to the invention the first and second spindle are situated on either side of the longitudinal axis of the tyre building drum. In that case it is furthermore advantageous when the first and second spindle are situated at the same distance from the longitudinal axis of the tyre building drum.

Although the spindles can for instance be driven by a planetary gear system, for the sake of simplicity of the construction, maintenance and accuracy of the drive, it is advantageous when each of the spindles is driven by its own servomotor.

### SHORT DESCRIPTION OF THE DRAWINGS

The invention will be elucidated on the basis of an exemplary embodiment shown in the attached drawings, in which:

FIG. 1 schematically shows a part of the inventive tyre building drum for building an unvulcanised tyre in cross-section, and

FIG. 2 schematically shows the drive of the spindles by servomotors.

### DETAILED DESCRIPTION OF THE DRAWINGS

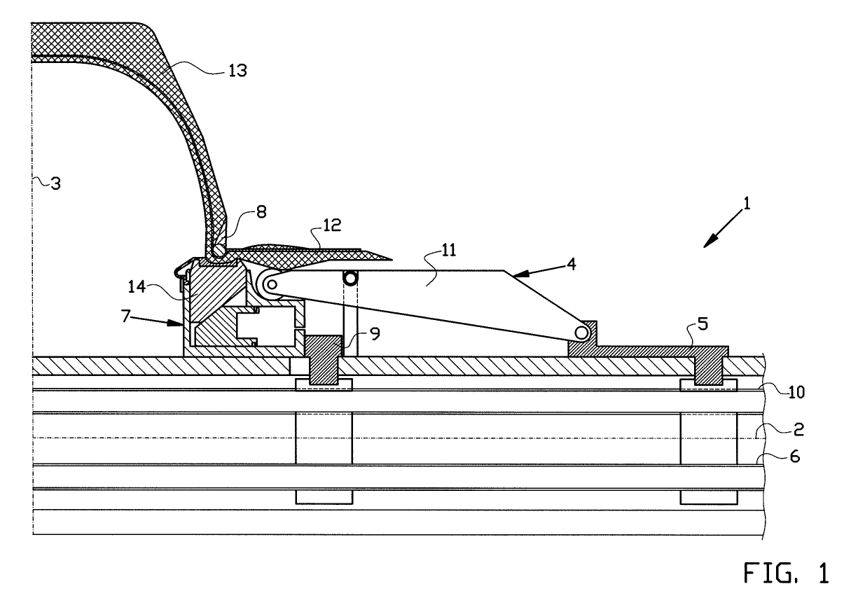

FIG. 1 shows a part of the inventive tyre building drum 1 for building an unvulcanised tyre in cross-section. The tyre building drum 1 is at least substantially axis symmetrical with respect to the longitudinal drum axis 2 and with respect to the middle of the drum 1. For this reason the building parts situated directly opposite are not shown in FIG. 1.

The tyre building drum 1 comprises two folding arm units 4 arranged at least substantially symmetrically with respect to the middle 3 of the tyre building drum 1, which folding arm units are connected to a folding arm bearing body 5 so as to swivel. Both folding arm bearing bodies 5 can be moved synchronously with respect to each other in axial direction of the tyre building drum 1, and namely via a first spindle 6.

The tyre building drum 1 further comprises two bead ring core units 7 arranged at least substantially symmetrically with respect to the middle 3 of the tyre building drum 1, each of the bead ring core units 7 being intended for supporting a bead ring core 8. Each bead ring core unit 7 comprises a bead ring core bearing body 9. Both bead ring core bearing bodies 9 can be moved synchronously with respect to each other in axial direction via a second spindle 10.

The first spindle 6 and the second spindle 10, in radial direction, that means considered transverse to the longitudinal axis 2, are spaced apart from each other, and as shown in FIG. 1 situated on either side of the longitudinal axis 2. In an alternative embodiment both spindles can also be situated on a same side of the axis 2. According to the embodiment shown in FIG. 1 the first 6 and second spindle 10 are situated at the same distance from the longitudinal axis 2 of the tyre building drum 1, although in alternative embodiments they may also be situated at different distances from the axis 2.

By using the first spindle 6 to move the folding arm bearing body 5 to the middle 3 of the tyre building drum 1, the arms 11 of the folding arm unit 4 are swivelled upwards, so that a side wall 12 is pressed around the bead ring core 8 and against a shaped carcass part 13. By using the second spindle 10 to move the bead ring core bearing body 9 to the middle 3 of the tyre building drum 1, the bead ring core 8 is pressed by a bead ring core pressing segment 14.

The thread 25, 26 of the first spindle 6 and the thread 27, 28 of the second spindle 10 on the side opposite the middle 3 of the drum 1 have the same pitch yet in an opposite direction, as schematically shown by the hatching, so that both folding arm units and both bead ring core units at rotation of the spindles in question move synchronously and symmetrically with respect to the middle 3 of the drum 1 towards each other.

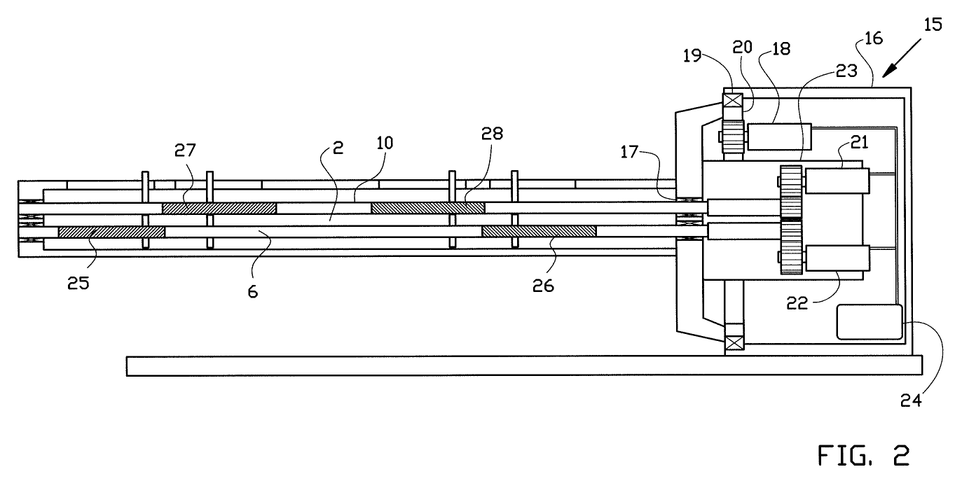

Both movements can be controlled fully independently from each other, as a result of which great freedom is achieved regarding the manner of folding tyre components. Particularly when each of the spindles 6, 10 is driven by its own servomotor, a highly accurate drive can be realised. A schematic diagram for the drive of the spindles 6, 10 by servomotors is schematically shown in FIG. 2.

The drive of the spindles 6 and 10 in the embodiment shown is realised by a drive unit 15 provided with a housing 16. The housing 16 in the embodiment shown is arranged symmetrically around the axis 2, although other configurations can also be used within the invention. In the housing 16 bearings 17 are arranged for bearing-mounting the spindles 6, 10. The drive unit 15 contains a driving motor 18 having a gear wheel for the drum axis 2, wherein the drum axis 2 is bearing-mounted in the housing by means of a ring bearing 19 and a crown gear 20 ensures driving the drum axis. The drive unit 15 further comprises a servomotor 21 with gear transmission for the spindle 10 and a separate servomotor 22 with gear transmission for spindle 6. The servomotors 21, 22 are attached to a supporting structure 23 that also supports the drum axis 2. The drive unit 15 furthermore comprises a control unit 24 for controlling the operation of the motors 18, 21 and 22.

The above description is included to illustrate the operation of preferred embodiments of the invention and not to limit the scope of the invention. Starting from the above explanation many variations that fall within the spirit and scope of the present invention, particularly as defined in the attached claims, will be evident to an expert.

1. Tyre building drum for building an unvulcanised tyre using tyre components of rubber, wherein the tyre building drum comprises two folding arm units arranged at least substantially symmetrically with respect to the middle of the tyre building drum, which folding arm units are each connected to a folding arm bearing body so as to swivel, wherein both folding arm bearing bodies can be moved in axial direction of the tyre building drum, wherein via a first spindle both folding arm bearing bodies can be moved synchronously with respect to each other in axial direction, wherein the tyre building drum further comprises two bead ring core units arranged at least substantially symmetrically with respect to the middle of the tyre building drum, each of the bead ring core units being intended for supporting a bead ring core, wherein each bead ring core unit comprises a bead ring core bearing body, wherein via a second spindle both bead ring core bearing bodies can be moved synchronously with respect to each other in axial direction, characterised in that the first spindle and the second spindle are spaced apart from each other in radial direction.

2. Tyre building drum according to claim 1, characterised in that the first and second spindle are situated on either side of the longitudinal axis of the tyre building drum.

3. Tyre building drum according to claim 2, characterised in that the first and second spindle are situated at the same distance from the longitudinal axis of the tyre building drum.

4. Tyre building drum according to claim 1, characterised in that each of the spindles is driven by its own servomotor.
